(19) United States
(12) Patent Application Publication
(10) Pub. No.: US 2022/0251749 A1
(43) Pub. Date: Aug. 11, 2022

(54) Thermal and Acoustic Fire Protection Felt

(71) Applicant: Southern Felt Company, Inc., North Augusta, SC (US)

(72) Inventors: Steven Gary BORCHARDT, Evans, GA (US); Richard BATES, Grovetown, GA (US); Brian JARRARD, Thurmond, NC (US)

(21) Appl. No.: 17/669,048

(22) Filed: Feb. 10, 2022

Related U.S. Application Data
(60) Provisional application No. 63/147,987, filed on Feb. 10, 2021.

(51) Int. Cl. D04H 3/153; D04H 3/009; D04H 3/011; B32B 5/26; D04H 3/002; H01M 50/249; H01M 50/293; H01M 10/658; B32B 5/02; B60R 13/08

(52) U.S. Cl. CPC D04H 3/153; B32B 2307/3065; D04H 3/011; B32B 5/273; D04H 3/002; H01M 50/249; H01M 50/293; H01M 10/658; B32B 5/028; B32B 5/022; B60R 13/0869; D10B 2401/04; D10B 2505/12; B32B 2255/02; B32B 2255/20; B32B 2255/26; B32B 2262/0276; B32B 2262/144; B32B 2457/10; B32B 2307/304; D04H 3/009

(57) ABSTRACT

A thermal insulation and fire protection felt product is provided. The felt product includes a first layer including a first plurality of nonwoven mechanically entangled oxidized polyacrylonitrile (PAN) precursor fibers bonded together by a first plurality of melted thermoplastic polyphenylene sulfide (PPS) fibers homogeneously mixed with the first plurality of mechanically entangled PAN precursor fibers. The first plurality of melted thermoplastic PPS fibers form a matrix of bond points between individual fibers of the first plurality of mechanically entangled PAN fibers. A second layer includes a second plurality of nonwoven mechanically entangled oxidized PAN precursor fibers bonded together by a second plurality of melted thermoplastic PPS fibers homogeneously mixed with the second plurality of mechanically entangled PAN precursor fibers. The second plurality of melted thermoplastic PPS fibers form a matrix of bond points between individual fibers of the second plurality of mechanically entangled PAN fibers.

### BACKGROUND AND SUMMARY OF THE INVENTION

Insulation materials may be manufactured using processes that cause the materials to exhibit undesirable properties, such as increased smoke and flammability when exposed to high temperatures. To counteract these properties, flame-retardant chemicals may be introduced, which may increase the costs of manufacturing due in part to the chemicals needed, as well as the associated application and drying costs.

Traditional system insulation designs may employ metal enclosures and heavily-filled inorganic materials. Both may provide protection and limit fire spread at the expense of increased weight and material costs, which may be undesirable in electric vehicles and rechargeable battery systems. Traditional insulation products may be made from inorganic fibrous materials which can provide thermal insulation properties and fire protection at the expense of significant health and safety concerns for manufacturers and component assembly workers. Insulation materials made with glass fibers, silica fibers, basalt fibers, and ceramic fibers may be used thermal and acoustic applications. However, there are growing concerns and limitations related to the health and safety of personnel who manufacture and handle insulation materials having these components. These insulation materials may present occupational hazards for workers via skin contact exposure and inhalation, for example.

This present subject matter discloses a thermal insulation and fire protection felt that may be constructed from a nonwoven blend of fibers, and which may provide fire protection, thermal insulation, and improved physical strength when compared with insulating materials of the prior art. The blend of fibers may include those that are resistant to high temperature, noncombustible, naturally flame retardant, and/or thermoplastic in nature. Moreover, these desirable characteristics may be achieved without incurring the additional costs associated with the corrective or counteractive procedures of the prior art.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a close-up view of an example thermal insulation and fire protection felt according to an embodiment of the present subject matter; and

FIG. 2 shows an example method of producing the thermal insulation and fire protection felt according to an embodiment of the present subject matter

FIG. 3 shows an example thermal insulation and fire protection felt product according to an embodiment of the present subject matter.

FIG. 4 shows a graph of the results of the Thermal Stability test performed on example sample embodiments of the present subject matter.

FIG. 5 shows a schematic diagram of a vehicle battery compartment in which the thermal insulation and fire protection felt may be disposed according to an embodiment of the present subject matter.

FIG. 6 shows example techniques of folding the thermal insulation and fire protection felt according to embodiments of the present subject matter.

### DETAILED DESCRIPTION OF THE DRAWINGS

The disclosed thermal insulation and fire protection felt may be constructed from a nonwoven blend of fibers that may be mechanically entangled to form a nonwoven material during manufacture. The resulting nonwoven fiber batting material may be heated to a predetermined minimum temperature to melt the thermoplastic resin fibers, which may be uniformly or non-uniformly distributed among the remaining fibers in the nonwoven blend. Melting the thermoplastic resin fibers may bond the remaining mechanically entangled fibers together by creating numerous bond points to form a matrix. The thermal insulation and fire protection felt disclosed in accordance with the present subject matter may provide improved stiffness, improved tensile strength, resistance to bending, improved bond strength, resistance to peeling, dimensional stability during processing, and reduced shrinkage during exposure to high temperatures when compared with insulating materials of the prior art.

The thermal insulation and fire protection felt disclosed in accordance with the present subject matter may be useful as an insulating material, which may be installed in applications requiring fire protection layers to protect system components and/or personnel from potentially high heat and/or fire. The improved physical properties of the disclosed thermal insulation and fire protection felt may also be useful in applications where an insulating material may be routinely subject to physical stresses, strain, abrasion, compression, impacts, bending, liquid saturation, frequent movement, vibration, impingement, and the like. These stresses may be applied to the insulating material both during normal use and during a system failure event, such as a fire, overheating, electrical arcing, and the like. The improved physical strength of the disclosed thermal insulation and fire protection felt may include enhanced protection against fire when exposed to high-velocity gases and high temperature conditions such as those produced during a thermal runaway event of a rechargeable energy storage system, for example.

The thermal insulation and fire protection felt disclosed in accordance with the present subject matter may be especially applicable to vehicle battery applications. For instance, the disclosed fire protection felt may be resistant to electrical conduction, which may be advantageous when installed in close proximity to high-voltage or high-current electrical systems. The disclosed fire protection felt may be installed near electrical wiring, bus bars, batteries, connectors, fuse and breaker panels, transformers, and the like, without risk of short circuit or electrical arcing. In some embodiments, the disclosed fire protection felt may be used in a battery compartment of a vehicle. The disclosed thermal insulation and fire protection felt, which exhibits high rigidity upon thermal bonding, may be used as an enclosure for one or more battery modules or battery packs of a vehicle.

Dielectric strength testing was performed on the disclosed thermal insulation and fire protection felt where a sample of the felt material was placed in between and in contact with two conductive plates under slight pressure. The voltage across the two plates was then increased until an electrical arc formed through the felt material. The test was conducted multiple times and the average values were recorded showing the voltage per inch or the voltage per mil (thousandths of an inch). The tested samples of the disclosed fire protection felt exhibited a dielectric strength ranging from 25 to 50 volts per mil (0.001 inch) or 25,000 to 50,000 volts per inch of felt material, depending on the particular fiber blend, thickness, and weight of the fire protection felt.

Testing also revealed that the disclosed thermal insulation and fire protection felt is very hydrophobic, which may be advantageous when used in proximity to electrical devices and connections. Specifically, a water droplet test was conducted where a five-millimeter droplet of water is placed on the surface of the thermal insulation and fire protection felt. The disclosed thermal insulation and fire protection felt was shown to hold the droplet of water for at least 30 seconds without being absorbed. In addition, the water-wicking test (SAE J913) was performed to show that the disclosed thermal insulation and fire protection felt did not wick water in a vertical orientation. These test results were obtained without the use of any conventional water-repelling treatment of the thermal insulation and fire protection felt.

Fibrous insulating materials of the prior art may have reduced applicability when compared with the thermal insulation and fire protection felt of the present subject matter. Prior art insulating materials may be of lower physical strength, lower durability, and exhibit poor resistance to cyclical physical stresses. As a result, prior art insulating materials may require the incorporation of costly additional structures to attempt to counteract and/or compensate for these deficiencies. For example, prior art insulating materials may require reinforcing metal panels, perforated metals, woven fabrics, protective coverings, and the like, to supplement the limited physical properties of the insulating material(s). Such protective materials may be utilized to prevent fracture and/or physical deterioration of the insulating material, and may also increase the complexity of manufacture due to the use of mechanical fasteners and adhesives to join the protective coverings to the insulating material(s).

As previously discussed, the thermal insulation and fire protection felt of the present subject matter may be composed of a nonwoven blend of fibers. The blend of fibers may include oxidized polyacrylonitrile (PAN) precursor fibers and polyphenylene sulfide (PPS) fibers mechanically combined and/or entangled using carding, cross lapping, calendering, and/or needle punching processes.

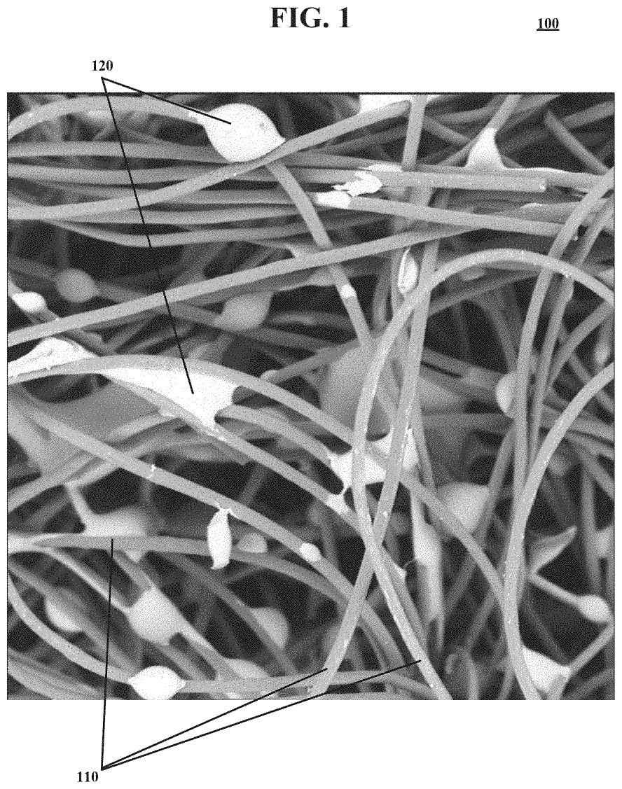

FIG. 1 shows an example photograph of the thermal insulation and fire protection felt 100 as captured using a scanning electron microscope having a 400× magnification. The thermal insulation and fire protection felt may include oxidized PAN fibers 110 and PPS fibers 120. The linear mass density (denier) of the PAN and PPS fibers may be selected based on the desired thermal, acoustic, and strength of the thermal insulation and fire protection felt 100. The oxidized PAN fibers 110 selected to be used in accordance with the present subject matter may range between about 1.5 denier to 15 denier, between about 1.5 denier and 4.5 denier, and/or about 2 denier. PPS fibers 120 selected to be used in accordance with the present subject matter may range between about 0.9 denier to 15 denier, between about 0.9 denier to 7 denier, and/or about 2.2 denier. Fibers of greater denier may be selected to provide additional physical strength and larger pore sizes. Fibers of greater denier may support greater insulation thicknesses but lower thermal insulation due to higher thermal conductivity. Fibers of greater denier may also exhibit lower acoustical absorption properties over lower denier fibers. Smaller denier fibers, with corresponding smaller fiber diameters, provide greater surface area when compared with larger diameter fibers, which thereby improve the thermal and acoustic properties.

The PPS fibers 120 may be melted or at least softened to bond the oxidized PAN fibers 110 as shown. The oxidized PAN fibers 110 may be processed to approximately 50-80% carbon content, 60-70% carbon content, and/or about 63% by weight. When processed in this manner, the oxidized PAN fibers 110 may provide improved fire resistance and improved resistance to melting when exposed to an open flame. On the other hand, nonwoven materials made from oxidized PAN fibers 110 alone via needle punching may exhibit reduced physical strength, as the fibers may only be held in place through friction. In addition to reduced physical strength, oxidized PAN fibers 110 may exhibit relatively low tensile strength (tenacity) of 2.3 grams per denier when compared with other fibers such as polyester, which may exhibit a tenacity of 3.5-5.5 grams per denier.

The fibers 120 may be made from a thermoplastic resin that is both resistant to heat and burning, such as PPS, polyester, such as homopolymer polyester, bicomponent polyester, or a blend of any of the fibers previously mentioned. Any of the fibers 120 may be further treated with flame-retardant as desired depending on the proportion of fibers 120 to oxidized PAN fibers 110. For example, a thermal insulation and fire protection felt 100 having a lower proportion of fibers 120, such as 7% polyester fibers 120, may not be treated with flame retardant while a higher proportion of polyester fibers 120, such as 30%, may be treated with flame retardant. The PPS fibers 120 may sustain burning in the presence of air having approximately 45% oxygen content or more and may not sustain or even support burning at all with the oxygen levels present in ambient air, thus defining its limiting oxygen index (LOI) as 45%. The PPS fibers 120 may be homogeneously and mechanically mixed with the oxidized PAN fibers 110 into a nonwoven fiber batting material and subsequently heated at least to a predetermined minimum melting temperature to create a matrix of bonding points among the nonwoven fiber batting. The numerous bonding points created during the thermal bonding process may increase the physical strength and rigidity of the resulting nonwoven material without introducing additional fuel sources, which may reduce the fire resistance and increase the flammability of the material. The improved rigidity achieved through the thermal bonding process may improve resistance to deflection under forces, such as high velocity air and gases during a potential thermal runaway event of a battery storage system. Through combining the PPS fibers 120 with the oxidized PAN fibers 110 in this manner, the physical properties of the thermal insulation and fire protection felt 100 may be increased when compared to a felt composed of the oxidized PAN fibers 110 alone without introducing additional chemicals or reinforcing/protective structures that would increase the costs of manufacture. For example, it has been found that a felt composed of PAN fibers alone may be too elastic, not dimensionally stable, especially when exposed to extreme heat, and more difficult to process using manufacturing equipment.

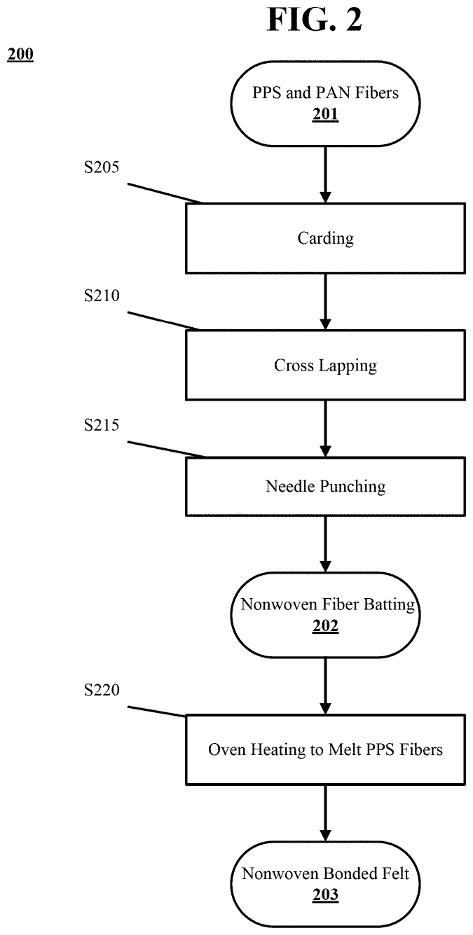

An example method 200 of producing the thermal insulation and fire protection felt is shown in FIG. 2. In this example, the thermal insulation and fire protection felt may be composed of 93% oxidized PAN fibers 110 blended and/or entangled with 7% PPS fibers 120 by weight. This proportion may provide a thermal insulation and fire protection felt that is soft and compressible with good lateral strength and resistance to stretching. A low-density needle felt material may have high elongation and stretch properties in the machine and cross machine directions. The high elongation may lead to problems during manufacturing processes, such as die cutting, as the material may distort during processing under tension. The resulting die-cut shape may vary dimensionally from the design intent, as the material may be easily stretched and deformed. Die-cut parts may be easily distorted during packaging, shipping, and installation, which may render it unsuitable, depending on the application. It may advantageous to use a low-density insulation material that provides high thermal protection and fire blocking but that also has dimensional stability during die cutting, handling, and installation. The present subject matter provides enhanced dimensional stability even for low density felts as described. The dimensional stability is enhanced via the thermal bonding process, which bonds the oxidized PAN fibers 110 together using thermoplastic resin fibers, such as PPS fibers 120 for example, which are heated to create numerous bond points in a non-woven matrix. The ratio of the thermoplastic resin fibers may be adjusted to increase the strength and dimensional stability of the final fire protection felt to meet the specific application needs of each implementation. For example, increasing the ratio of PPS fibers 120 will increase the tensile strength, reduce the elongation of the felt under constant load, and increase the dimensional stability of the felt while reducing the thermal protection and fire blocking properties attributable to the oxidized PAN fibers 110.

The fibers 201 may be processed using a carding machine in S205, a cross-lapping machine in S210, and a needle punch loom in S215 to construct a nonwoven fiber batting 202. The nonwoven fiber batting 202 may be produced in a wide range of weights, such as between 7 ounces per square yard (OSY) and 50 OSY, (237.34 to 1695.29 grams per square meter (GSM)), 7 OSY to 25 OSY, and/or 7 OSY to 15 OSY, depending on the desired thickness and fire protective properties. After carding (S205), cross lapping (S210) and needle punching (S215), the nonwoven fiber batting 202 may be subjected to a heating process in S220. In an embodiment, a flow-through oven may be utilized to heat the nonwoven fiber batting 202 to a temperature above approximately 280° Celsius such that the PPS fibers 120 are melted or at least softened to produce the finished nonwoven, bonded, thermal insulation and fire protection felt 203. The amount of heating applied to the nonwoven fiber batting 202 in S220 may be varied to achieve a range of physical properties. For example, heating the nonwoven fiber batting 220 to where the PPS fibers 120 are merely softened may increase the rigidity and strength of the final thermal insulation and fire protection felt 203 to a lesser extent than where the PPS fibers 120 are fully melted. While heating of the nonwoven fiber batting 220 may initially cause a 2-5% loss of mass due to the evaporation of moisture within the material, this loss of mass may be temporary. Upon cooling, the mass of the felt material may be restored upon exposure to the humidity naturally present in ambient air.

The finalized nonwoven thermal insulation and fire protection felt 203 may include a matrix of oxidized PAN fibers 110 with PPS resin fibers, which have been melted to form a plurality of bond points, thus providing durability, increased physical strength, dimensional stability under heat and fire exposure, and low combustibility combined with fire blocking properties. Additionally, the finalized nonwoven thermal insulation and fire protection felt 203 may achieve increased resistance to shrinkage, curling, and “move away” when exposed to flame when compared with the unbonded nonwoven fiber batting 202. This property may be useful as a fire and heat-blocking material during a potential thermal runaway event of a battery pack. In an example, the final bonded, nonwoven, thermal insulation and fire protection felt 203 may weigh approximately 22.5 OSY with a thickness of approximately 0.25 inches. In another example, the final bonded, nonwoven, thermal insulation and fire protection felt 203 may weigh approximately 11.25 OSY with a thickness of approximately 0.15 inches.

It should be appreciated that the proportions of oxidized PAN fibers 110 and PPS fibers 120, as well as the fiber weights may be adjusted, depending on the desired performance characteristics of the thermal insulation and fire protection felt. For example, the proportion of PPS fibers 120 may fall within a range between approximately 3% and 70% of the overall nonwoven blend without departing from the scope of the present subject matter. In an embodiment, the proportion of blended fibers used to construct the thermal insulation and fire protection felt may be composed of about 70% oxidized PAN fibers 110 blended with about 30% PPS fibers 120 by weight. A higher PPS fiber proportion may create more bond points and thus, increase the physical strength of the resulting fire protection felt at the expense of reducing the fire-blocking properties, which may be attributed to the correspondingly lower proportion of the oxidized PAN fibers 110, and vice versa. Additionally, a higher PPS fiber proportion may make the resulting fibrous batt more rigid and less flexible than fibrous batts composed of a smaller proportion of PPS fibers.

The oxidized PAN fibers 110 and PPS fibers 120 may also be substituted with other types of fibers having similar properties without departing from the scope of the present subject matter. In an example, the oxidized PAN fibers 110 may be substituted with another fire-blocking fibrous material, such as glass fibers, silica fibers, ceramic fibers, and/or basalt fibers, which may be associated with various health, safety, and handling constraints. In general, a suitable fiber material replacement for the oxidized PAN fibers 110 should preferably exhibit stability when exposed to open flame temperatures of approximately 1200° Celsius or greater. Up to 100% of the oxidized PAN fibers 110 may be substituted with inorganic fibers but preferably substitution of the oxidized PAN fibers 110 is limited to 30-40% of inorganic fibers by weight. Alternatively, or in addition, inorganic fibers may also be substituted for the PPS fibers 120, or a combination of both substituting inorganic fibers for the oxidized PAN fibers 110 and PPS fibers 120. Utilizing inorganic fibers, such as the glass fibers, silica fibers, ceramic fibers, basalt fibers, and/or other organic fibers may improve the high-temperature resistance of the thermal insulation and fire protection felt 100 and/or reduce mass loss during exposure to high temperatures. On the other hand, limiting the inorganic fibers to a maximum of 40% by weight may reduce or eliminate the health and safety risks associated with these fibers when used in greater proportions, including reducing the irritation risks and/or inhalation risks. As used herein, organic fibers shall be understood to mean fibers containing at least a proportion of carbon, while inorganic fibers lack any proportion of carbon. The PPS fibers 120 may be substituted with a suitable flame-retardant polyester, which may be similarly heated to melt and bind the oxidized PAN fibers 110 or PAN fiber blend to one another as in the case with the PPS fibers 120.

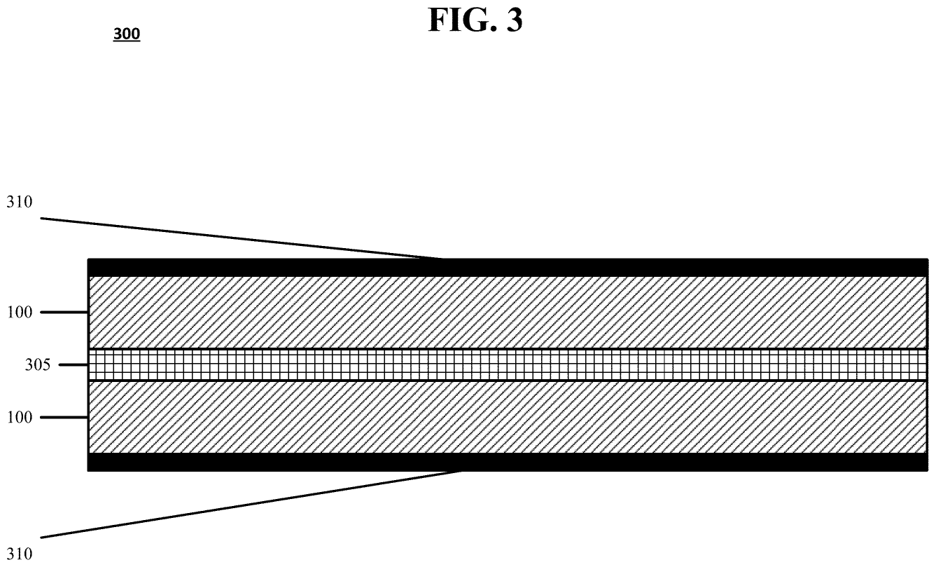

FIG. 3 shows an example thermal insulation and fire protection felt product 300 that combines two layers of the thermal insulation and fire protection felt 100 previously described with a scrim 305 and surface coating 310. While both the scrim 305 and surface coating 310 are shown used together in the thermal insulation and fire protection felt product 300 of FIG. 3, it should be appreciated that both the scrim 305 and surface coating 310 are optional and may be used individually or in combination depending on the application needs.

The scrim 305 may be constructed using a plain weave and/or a leno weave from high-temperature materials, such as silica, ceramic, metals, such as stainless steel or Inconel, other high temperature materials, or a blend of any of the previously mentioned materials. Where metal materials are incorporated within the scrim 305, it should be appreciated that surrounding thermal insulation and fire protection felts 100 should be of suitable thickness and coverage to prevent any exterior surface of the overall thermal insulation and fire protection felt product 300 from becoming electrically conductive when subjected to typical vehicle battery voltages. The scrim 305 may be composed of filament fibers and/or yarn fibers that may overlap in the machine and/or cross machine direction. Yarn fibers, as used herein, are spun fibers of a shorter length that are carded into a batt and then twisted into yarns. Preferably, filament fibers are used in the scrim 305 in accordance with the present subject matter because inorganic fibers, such as silica fibers and ceramic fibers have proven to be difficult to twist into yarns. The scrim 305 may also be woven with PPS fibers 120 such as those previously described to increase the strength and rigidity of the scrim 305. The scrim 305, while being composed of high-temperature materials, may be more vulnerable to direct flame and/or hot gas exposure than the thermal insulation and fire protection felts 100 and may be disposed centrally or otherwise in between layers of the thermal insulation and fire protection felts 100 as shown in FIG. 3 for this reason. The scrim 305 may provide higher overall strength for the thermal insulation and fire protection felt product 300, and may provide higher strength when exposed to high temperatures (i.e., hot strength). The scrim 305 may be joined to the thermal insulation and fire protection felts 100 through needle punching the felt 100 and scrim 305 layers together, although other techniques to join the materials may be used, such as adhesive bonding, ultrasonic bonding, and the like. In an example embodiment, the scrim 305 may be disposed between two layers of 237 GSM thermal insulation and fire protection felt 100 such that the weight of the bonded product is 475 GSM.

The surface coating 310 may be provided on one or more exterior sides of the thermal insulation and fire protection felt product 300 and/or may be provided on only an exterior side of the thermal insulation and fire protection felt product 300 facing a heat source, such as a vehicle battery pack. The surface coating 310 may be composed of silicone rubber, ceramic, or other intumescent coatings and applied at a thickness between a few fractions of a millimeter and one millimeter, preferably 0.2 to 0.5 millimeters thick. The surface coating 310 may further include fillers that may improve fire and heat resistance of the surface coating 310. The surface coating 310 may reduce the porosity of the thermal insulation and fire protection felt product 300 by forming a semi-impermeable barrier against high temperature gases and flame. An interesting feature is that the surface coating 310 may protect the underlying thermal insulation and fire protection felts 100 by providing resistance to fraying and abrasion. Another interesting feature of the surface coating 310 may be that exposure to hot gases and/or flame may produce a protective, insulating layer of char. Preferably, the layer of char formed may be up to 6 millimeters thick upon exposure to hot gases and/or flame. Another interesting feature is that the surface coating 310 may reduce the permeability of the thermal insulation and fire protection felt product 300 such that the convective heat transfer is reduced, which may improve the temperature differential by lowering the temperature on the (cold) side of the thermal insulation and fire protection felt product 300 opposite the side facing the heat source.

The thermal insulation and fire protection felt product 300 may be provided as flexible batts and/or rigid panels in a variety of material weights and thicknesses. In a first example embodiment, the thermal insulation and fire protection felt product 300 is provided as a rigid panel having a thickness of 2 to 3 millimeters, preferably 2.4 millimeters (+/−0.3 millimeters) with a surface weight of 425 to 525 GSM, preferably 475 GSM, and having a construction of 30% PPS fibers and 70% oxidized PAN fibers by weight. In a second example embodiment, the thermal insulation and fire protection felt product 300 is provided as a flexible batt having a thickness of 2 to 4 millimeters, preferably 3 millimeters (+/−0.4 millimeters) with a surface weight of 340 to 420 GSM, preferably 382 GSM, and having a construction of 7% PPS fibers and 93% oxidized PAN fibers by weight. In a third example embodiment, the thermal insulation and fire protection felt product 300 is provided as a flexible batt having a thickness of 5 to 7 millimeters, preferably 6 millimeters (+/−0.8 millimeters) with a surface weight of 685 to 840 GSM, preferably 763 GSM, and having a construction of 7% PPS fibers and 93% oxidized PAN fibers by weight. Testing results of the first, second, and third example embodiments can be seen in the table below. It should be appreciated that each of the first, second, and third example embodiments tested below did not include the scrim 305 or the surface coating 310.

| | Test | | First | Second | Third |
|---|---|---|---|---|---|
| Property | Method | Units | Embodiment | Embodiment | Embodiment |
| Style | N/A | N/A | Rigid Panel | Flexible Batt | Flexible Batt |
| Thickness | ASTM | mm | 2.4 +/− 0.3 | 3 +/− 0.4 | 6 +/− 0.8 |
| | D1777 | | | | |
| Surface Mass | Calculated | g/m² | 475 | 382 | 763 |
| | | (GSM) | | | |
| Flammability | FMVSS302/ | N/A | DNI (did not | DNI | DNI |
| | SAE J369 | | ignite) | | |
| Flammability | UL94 | Rating | V-0 | V-0 | V-0 |
| Thermal | ASTM | W/m-K | 0.036 | 0.035 | 0.035 |
| Conductivity | C518 | | | | |
| Tensile | ASTM | N/cm | MD (machine | MD = 15 | MD = 36 |
| Strength | D5034 | | direction) = 45 | CD = 10 | CD = 28 |
| | | | CD (cross | | |
| | | | machine | | |
| | | | direction) = 22 | | |
| Tear | ASTM | N | MD = 55 | MD = 52 | MD = 131 |
| Strength | D5733 | | CD = 42 | CD = 71 | CD = 138 |
| Dielectric | ASTM | V/mil | >27 | >30 | >35 |
| Strength | D149 | 10⁶ V/m | >1.1 | >1.18 | >1.38 |
| | Method C | | | | |
| Thermal | Bunsen | Time vs | >1100° C. for | >1100° C. for | >1100° C. for |
| Stability | Burner High | ° C. | minimum of | minimum of | minimum of |
| | Intensity | | 10 minutes. | 10 minutes. | 10 minutes. |
| | Flame | | | | |

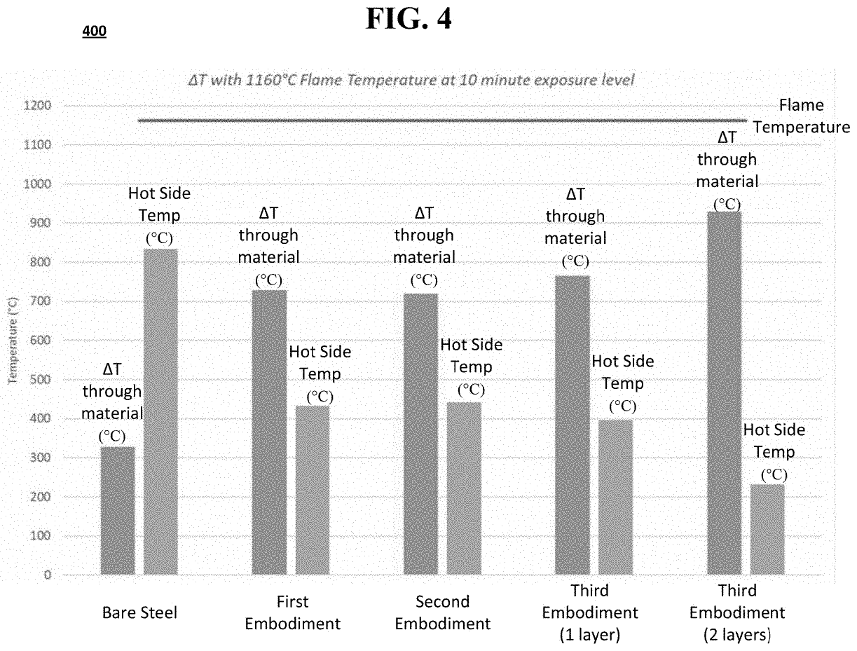

FIG. 4 further shows a graph 400 of the results of the Thermal Stability test for each of the example first, second, and third embodiments referenced in the previous table.

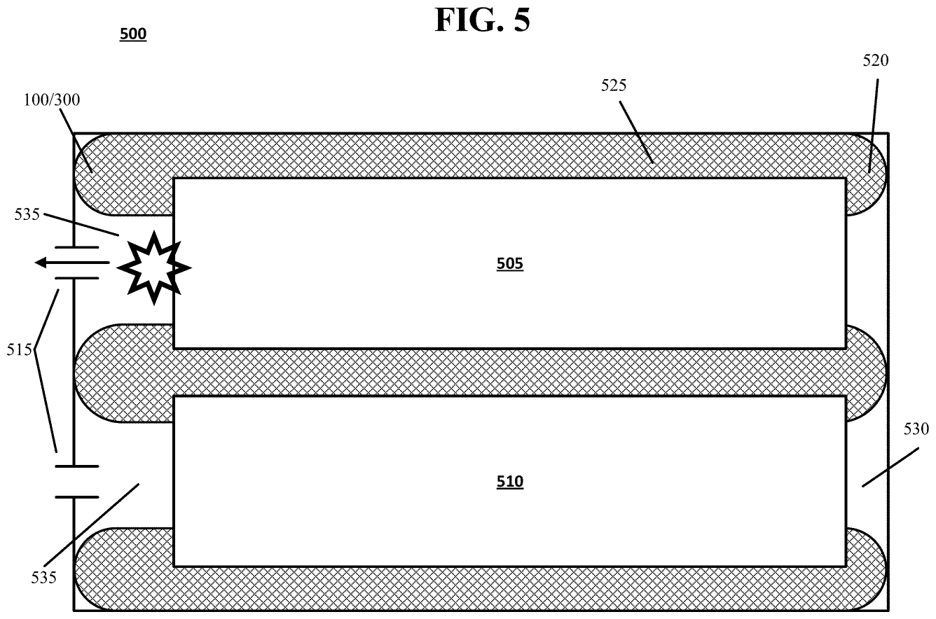

FIG. 5 shows an example embodiment 500 where the thermal insulation and fire protection felt 100 or felt product 300 may be installed within a vehicle battery compartment 530. The thermal insulation and fire protection felts and/or felt products 100/300 may be disposed between adjacent battery modules 505/515 such that a portion of the felt 100/300 is compressed 525 and a portion 520 is expanded to seal the battery modules 505/515 from one another and to seal off various channels of the vehicle battery compartment 530. As shown in FIG. 5, the thermal insulation and fire protection felts and/or felt products 100/300 may create pathways and blockades to divert hot gases and/or flame to one or more channels 535 leading to vents 515 of the vehicle battery compartment 530 when a battery module 505 experiences a thermal runaway event. In this way, the hot gases and/or flame produced by the battery module 505 experiencing the thermal runaway event may be diverted safely while reducing the risk of burning through the vehicle battery compartment 530 or causing the thermal runaway event to propagate to one or more adjacent battery modules 510.

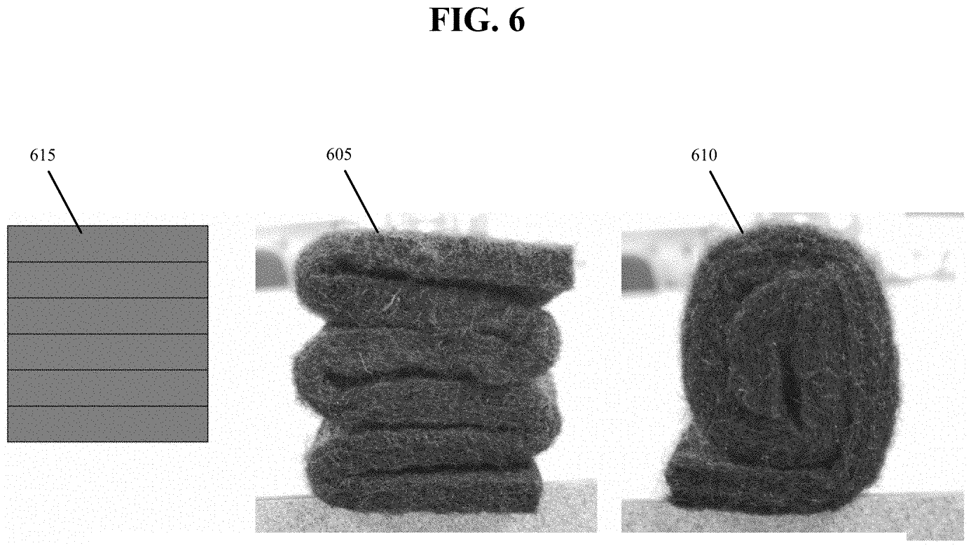

As shown in FIG. 6, any of the disclosed thermal insulation and fire protection felts and felt products 100/300, preferably those felts that do not have a surface coating 310 applied, may be folded in an alternating manner (e.g., accordion shape 605) or spiral folded 610 and assembled with anchor tags to create a desired felt thickness. Alternatively, or in addition, the disclosed thermal insulation and fire protection felts may be cut, stacked, and fastened 615 with anchor tags to create a desired felt thickness. For example, anchor tags sold under the Avery Dennison® trademark, to create six to nine felt layers having a thickness between 40 and 60 millimeters. The anchor tags may be composed of low temperature plastic and be used an assembly aid prior to installation of the thermal insulation and fire protection felt and felt products 100/300. The additional thickness created by folding and/or cutting and stacking the thermal insulation and fire protection felts and felt products 100/300 may be disposed between battery modules in a vehicle battery compartment, for example. This may be useful to prevent a hot gas or flame erupting from a battery module from reaching an adjacent second battery module, which could cause the second battery module to undergo a thermal runaway event in a cascading fashion.

The overall thickness of the thermal insulation and fire protection felt 100, whether folded or not, may be selected such that five to twelve millimeters of interference exists when installed, such as within an enclosure of a vehicle, for example. This amount of interference may allow the thermal insulation and fire protection felt 100 to provide suitable expansion, compression, and sealing against the enclosure and components disposed therein while still allowing those components to be installed and removed without undue force. For example, it has been determined that installing the disclosed thermal insulation and fire protection felts and felt products 100/300 with greater than five to twelve millimeters of interference inhibits the ability of a technician to install and/or remove a battery module component, an enclosure lid, and/or the like without the assistance of additional equipment or personnel. Conversely, when the acoustic and fire protection felt 100 is installed with less than five to twelve millimeters of interference, expansion of the thermal acoustic and fire protection felt 100 is inadequate for sealing and channeling hot gases and/or flame during a thermal runaway event. Therefore, it is preferable to select a thickness and/or number of folds for the thermal insulation and fire protection felts and felt products 100/300 such that when installed the interference is limited to five to twelve millimeters. This may assure ease of installation and removal of other components disposed in proximity to the thermal insulation and fire protection felt 100 while providing suitable sealing against those components and the surrounding enclosure.

The processes employed to form the previously-discussed nonwoven fiber batting may include carding and cross-lapping, air-laid, or in-line carding. The fiber bonding processes may include needle punching, hydroentangling, calendering, compressive belt thermal bonding, stitch bonding, and the like. Alternatively, or in addition, the thermal insulation and fire protection felt may also be produced as a woven, rather than nonwoven material. In that case, a woven textile manufacturing process may be employed where the mix of oxidized PAN fibers 110 and PPS fibers 120 may be blended into base yarns, which may be subsequently processed by weaving or knitting. A woven thermal insulation and fire protection felt 203 may provide increased tensile strength in the machine and cross machine directions due to continuous yarns used in the base fabric but at a greater material cost. The previously-discussed thermal bonding process to create the bonding points may be achieved using a flow-through oven, Stentor oven, infrared ovens, hot roll calendering, and/or open-flame burner.

Flammability performance of an insulation material may be measured using horizontal burn tests, such as the FMVSS302/SAE J369 test, or a vertical burn test such as the UL94 test. As previously described with reference to the table, the first, second, and third embodiments of the thermal insulation and fire protection felt 100 of the present subject matter achieves the highest level of performance in these tests resulting in a “does not ignite” (DNI) rating when tested using the horizontal burn tests and achieves a “V0” rating when tested using the vertical burn tests.

In addition to the noncombustible performance of the disclosed thermal insulation and fire protection felt, the felt may also provide a flame barrier to nearby components or systems that need protection from high-temperature conditions, such as fire. During exposure to open flames, the thermal insulation and fire protection felt may predominantly remain intact and create a fire-blocking insulation layer, which may prevent fire and high temperatures from propagating to the vulnerable subject(s) to be protected. This high degree of fire-blocking performance when combined with the outstanding physical properties makes the disclosed thermal insulation and fire protection felt 203 ideal for applications where insulation may be needed to protect the vulnerable subject(s) from fire while also withstanding physical stresses that occur during normal, everyday use, such as compression, bending, impacts, liquid saturation, movement, impingement, and vibration. Additionally, the disclosed thermal insulation and fire protection felt 203 meets or exceeds the performance of prior art fire-protective materials, such as metal enclosures, with a substantial savings in weight. Potential applications for the disclosed thermal insulation and fire protection felt 203 may include rechargeable energy store systems, automotive applications, electrical generators, and the like, wherever protection from fire and material durability may be desired.

As previously described with referenced to the table, tensile strength tests were performed on the first example embodiment of the thermal insulation and fire protection felt 203. A sample of the previously-described example first embodiment having a fabric weight of 475 GSM with an example composition blend of 30% PPS fibers 120 and 70% oxidized PAN fibers 110 by weight (the previously described example first embodiment) was tested. The length of this example sample was 3.000 inches and subjected to a pretension of 1.000 lbf. The tensile strength was tested before and after heating to achieve thermal bonding of the nonwoven fiber batting 202 previously described. When tested in the “machine direction,” the thermal bonding resulted in an increase of Young's Modulus by a factor of about 11.3 when compared with the same test measurement performed prior to thermal bonding. When tested in the “cross machine direction,” the result of the thermal bonding resulted in an increase of Young's Modulus by a factor of 4.3 when compared with the test measurement performed prior to thermal bonding. In both cases, the example first embodiment sample became substantially more rigid and resistant to stretching and change of shape after thermal bonding. These material properties improve the dimensional stability of the thermal insulation and fire protection felt, which may be advantageous during handling, cutting, and installing, for example. The example first embodiment material, having a proportion of 30% PPS fibers 120, when heated to form a matrix of bonding points with the oxidized PAN fibers 110, produces a felt product having “board-like” rigidity suitable for creating a battery module cover and/or enclosure for use in a vehicle, for example.

The foregoing disclosure has been set forth merely to illustrate the invention and is not intended to be limiting. Examples have been selected merely to further illustrate features, advantages, and other details of the present subject matter. While examples may serve this purpose, the particular material compositions, amounts, proportions, and other conditions should not be construed in a limiting manner. Since modifications of the disclosed embodiments incorporating the spirit and substance of the invention may occur to persons skilled in the art, the invention should be construed to include everything within the scope of the appended claims and equivalents thereof.

The subject-matter of the disclosure may also relate, among others, to the following aspects:

A first aspect relates to a thermal insulation and fire protection felt that may include: a plurality of nonwoven mechanically entangled fibers bonded together by a plurality of melted thermoplastic resin fibers homogeneously mixed with the plurality of mechanically entangled fibers, wherein the plurality of melted thermoplastic resin fibers form a matrix of bond points between individual fibers of the plurality of mechanically entangled fibers, and the thermal insulation and fire protection felt does not ignite when subjected to one or more of FMVSS302 or SAE J369 horizontal burn tests and/or obtains a V0 rating when subjected to UL94 vertical burn test.

A second aspect relates to the thermal insulation and fire protection felt of the first aspect, wherein the plurality of mechanically entangled fibers comprises oxidized polyacrylonitrile (PAN) precursor fibers.

A third aspect relates to the thermal insulation and fire protection felt of any preceding aspect, wherein the plurality of melted thermoplastic resin fibers comprises polyphenylene sulfide (PPS).

A fourth aspect relates to the thermal insulation and fire protection felt of any preceding aspect, wherein the plurality of melted thermoplastic resin fibers comprise polyester.

A fifth aspect relates to the thermal insulation and fire protection felt of any preceding aspect, further comprising: first and second layers each comprising the thermal insulation and fire protection felt of any preceding aspect, and a scrim disposed between and bonded to the first and second layers.

A sixth aspect relates to the thermal insulation and fire protection felt of any preceding aspect, further comprising: a coating applied to an exterior surface of the thermal insulation and fire protection felt product, wherein the coating comprises a silicone, ceramic, and/or an intumescent coating.

A seventh aspect relates to the thermal insulation and fire protection felt of any preceding aspect, wherein the plurality of mechanically entangled fibers further comprises a maximum of 40% by weight of a plurality of inorganic fibers and a remaining plurality of organic fibers.

An eighth aspect relates to the thermal insulation and fire protection felt of any preceding aspect, wherein the PAN fibers comprise between 60% and 70% carbon by weight.

A ninth aspect relates to a vehicle battery compartment comprising: a vent to allow hot gases to exit the vehicle battery compartment; a plurality of battery modules disposed within the vehicle battery compartment; and the thermal insulation and fire protection felt of any preceding aspect disposed between the plurality of battery modules, wherein a first portion of the thermal insulation and fire protection felt is compressed, a second portion of the thermal insulation and fire protection felt is expanded, and the first and second portions of the thermal insulation and fire protection felt create a path to divert hot gases from at least one of the plurality of battery modules to the vent of the vehicle battery compartment.

A tenth aspect relates to the thermal insulation and fire protection felt of any preceding aspect, wherein a proportion of the melted thermoplastic resin fibers is 30% by weight of the thermal insulation and fire protection felt.

An eleventh aspect relates to the thermal insulation and fire protection felt of any preceding aspect, wherein the thermal insulation and fire protection felt exhibits board-like rigidity.

A twelfth aspect relates to the thermal insulation and fire protection felt of any preceding aspect, wherein a proportion of the melted thermoplastic resin fibers is 3% by weight of the thermal insulation and fire protection felt.

A thirteenth aspect relates to the thermal insulation and fire protection felt of any preceding aspect, wherein the thermal insulation and fire protection felt is folded in an alternating manner and fastened to itself.

A fourteenth aspect relates to the thermal insulation and fire protection felt of any preceding aspect, wherein the plurality of melted thermoplastic resin fibers exhibit a limiting oxygen index (LOI) of 45%.

A fifteenth aspect relates to the thermal insulation and fire protection felt of any preceding aspect, felt of claim 1, wherein an exterior surface of the thermal insulation and fire protection felt exhibits a dielectric strength of 25 to 50 volts per mil.

A sixteenth aspect relates to a thermal insulation and fire protection felt product comprising: a first layer comprising: a first plurality of nonwoven mechanically entangled oxidized polyacrylonitrile (PAN) precursor fibers bonded together by a first plurality of melted thermoplastic polyphenylene sulfide (PPS) fibers homogeneously mixed with the first plurality of mechanically entangled PAN precursor fibers, wherein the first plurality of melted thermoplastic PPS fibers form a matrix of bond points between individual fibers of the first plurality of mechanically entangled PAN fibers; a second layer comprising: a second plurality of nonwoven mechanically entangled oxidized PAN precursor fibers bonded together by a second plurality of melted thermoplastic PPS fibers homogeneously mixed with the second plurality of mechanically entangled PAN precursor fibers, wherein the second plurality of melted thermoplastic PPS fibers form a matrix of bond points between individual fibers of the second plurality of mechanically entangled PAN fibers; a scrim layer disposed between the first and second layers; and a coating applied to an exterior surface of the thermal insulation and fire protection felt product, wherein the coating is formed from silicone, ceramic, or an intumescent coating.

A seventeenth aspect relates to the thermal insulation and fire protection felt of the sixteenth aspect, wherein the plurality of melted thermoplastic PPS fibers exhibit a limiting oxygen index (LOI) of 45%.

An eighteenth aspect relates to a thermal insulation and fire protection felt product comprising: a first layer comprising: a first plurality of nonwoven mechanically entangled oxidized polyacrylonitrile (PAN) precursor fibers bonded together by a first plurality of melted thermoplastic polyphenylene sulfide (PPS) fibers homogeneously mixed with the first plurality of mechanically entangled PAN precursor fibers, wherein the first plurality of melted thermoplastic PPS fibers form a matrix of bond points between individual fibers of the first plurality of mechanically entangled PAN fibers; a second layer comprising: a second plurality of nonwoven mechanically entangled oxidized PAN precursor fibers bonded together by a second plurality of melted thermoplastic PPS fibers homogeneously mixed with the second plurality of mechanically entangled PAN precursor fibers, wherein the second plurality of melted thermoplastic PPS fibers form a matrix of bond points between individual fibers of the second plurality of mechanically entangled PAN fibers; and a scrim layer disposed between the first and second layers, wherein the thermal insulation and fire protection felt does not ignite when subjected to one or more of FMVSS302, and/or SAE J369 horizontal burn tests and/or obtains a V0 rating when subjected to UL94 vertical burn test.

A nineteenth aspect relates to the thermal insulation and fire protection felt of the eighteenth aspect, wherein the scrim comprises filament fibers woven with a third plurality of melted PPS fibers.

A twentieth aspect relates to the thermal insulation and fire protection felt of the eighteenth or nineteenth aspects, wherein the first or the second plurality of mechanically entangled PAN fibers comprises a maximum of 40% by weight of a plurality of inorganic fibers and a remaining plurality of organic fibers.

In addition to the features mentioned in each of the independent aspects enumerated above, some examples may show, alone or in combination, the optional features mentioned in the dependent aspects and/or as disclosed in the description above and shown in the figures.

What is claimed is:

1. A thermal insulation and fire protection felt comprising:
a plurality of nonwoven mechanically entangled fibers bonded together by a plurality of melted thermoplastic resin fibers homogeneously mixed with the plurality of mechanically entangled fibers, wherein
the plurality of melted thermoplastic resin fibers form a matrix of bond points between individual fibers of the plurality of mechanically entangled fibers, and
the thermal insulation and fire protection felt does not ignite when subjected to one or more of FMVSS302 or SAE J369 horizontal burn tests and/or obtains a V0 rating when subjected to UL94 vertical burn test.

2. The thermal insulation and fire protection felt of claim 1, wherein
the plurality of mechanically entangled fibers comprises oxidized polyacrylonitrile (PAN) precursor fibers.

3. The thermal insulation and fire protection felt of claim 1, wherein
the plurality of melted thermoplastic resin fibers comprises polyphenylene sulfide (PPS).

4. The thermal insulation and fire protection felt of claim 1, wherein
the plurality of melted thermoplastic resin fibers comprise polyester.

5. A thermal insulation and fire protection felt product comprising:
first and second layers each comprising the thermal insulation and fire protection felt of claim 1; and
a scrim disposed between and bonded to the first and second layers.

6. The thermal insulation and fire protection felt product of claim 5, further comprising:
a coating applied to an exterior surface of the thermal insulation and fire protection felt product, wherein
the coating comprises a silicone, ceramic, and/or an intumescent coating.

7. The thermal insulation and fire protection felt of claim 1, wherein
the plurality of mechanically entangled fibers further comprises a maximum of 40% by weight of a plurality of inorganic fibers and a remaining plurality of organic fibers.

8. The thermal insulation and fire protection felt of claim 2, wherein the PAN fibers comprise between 60% and 70% carbon by weight.

9. A vehicle battery compartment comprising:
a vent to allow hot gases to exit the vehicle battery compartment;
a plurality of battery modules disposed within the vehicle battery compartment; and
the thermal insulation and fire protection felt of claim 1 disposed between the plurality of battery modules, wherein
a first portion of the thermal insulation and fire protection felt is compressed,
a second portion of the thermal insulation and fire protection felt is expanded, and
the first and second portions of the thermal insulation and fire protection felt create a path to divert hot gases from at least one of the plurality of battery modules to the vent of the vehicle battery compartment.

10. The thermal insulation and fire protection felt of claim 1, wherein
a proportion of the melted thermoplastic resin fibers is 30% by weight of the thermal insulation and fire protection felt.

11. The thermal insulation and fire protection felt of claim 10, wherein
the thermal insulation and fire protection felt exhibits board-like rigidity.

12. The thermal insulation and fire protection felt of claim 1, wherein
a proportion of the melted thermoplastic resin fibers is 3% by weight of the thermal insulation and fire protection felt.

13. The thermal insulation and fire protection felt of claim 1, wherein
the thermal insulation and fire protection felt is folded in an alternating manner and fastened to itself.

14. The thermal insulation and fire protection felt of claim 1, wherein
the plurality of melted thermoplastic resin fibers exhibit a limiting oxygen index (LOI) of 45%.

15. The thermal insulation and fire protection felt of claim 1, wherein
an exterior surface of the thermal insulation and fire protection felt exhibits a dielectric strength of 25 to 50 volts per mil.

16. A thermal insulation and fire protection felt product comprising:
a first layer comprising:
a first plurality of nonwoven mechanically entangled oxidized polyacrylonitrile (PAN) precursor fibers bonded together by a first plurality of melted thermoplastic polyphenylene sulfide (PPS) fibers homogeneously mixed with the first plurality of mechanically entangled PAN precursor fibers, wherein
the first plurality of melted thermoplastic PPS fibers form a matrix of bond points between individual fibers of the first plurality of mechanically entangled PAN fibers;
a second layer comprising:
a second plurality of nonwoven mechanically entangled oxidized PAN precursor fibers bonded together by a second plurality of melted thermoplastic PPS fibers homogeneously mixed with the second plurality of mechanically entangled PAN precursor fibers, wherein
the second plurality of melted thermoplastic PPS fibers form a matrix of bond points between individual fibers of the second plurality of mechanically entangled PAN fibers;
a scrim layer disposed between the first and second layers; and
a coating applied to an exterior surface of the thermal insulation and fire protection felt product, wherein
the coating is formed from silicone, ceramic, or an intumescent coating.

17. The thermal insulation and fire protection felt product of claim 16, wherein
the plurality of melted thermoplastic PPS fibers exhibit a limiting oxygen index (LOI) of 45%.

18. A thermal insulation and fire protection felt product comprising:
a first layer comprising:
a first plurality of nonwoven mechanically entangled oxidized polyacrylonitrile (PAN) precursor fibers bonded together by a first plurality of melted thermoplastic polyphenylene sulfide (PPS) fibers homogeneously mixed with the first plurality of mechanically entangled PAN precursor fibers, wherein
the first plurality of melted thermoplastic PPS fibers form a matrix of bond points between individual fibers of the first plurality of mechanically entangled PAN fibers;
a second layer comprising:
a second plurality of nonwoven mechanically entangled oxidized PAN precursor fibers bonded together by a second plurality of melted thermoplastic PPS fibers homogeneously mixed with the second plurality of mechanically entangled PAN precursor fibers, wherein
the second plurality of melted thermoplastic PPS fibers form a matrix of bond points between individual fibers of the second plurality of mechanically entangled PAN fibers; and
a scrim layer disposed between the first and second layers, wherein
the thermal insulation and fire protection felt does not ignite when subjected to one or more of FMVSS302, and/or SAE J369 horizontal burn tests and/or obtains a V0 rating when subjected to UL94 vertical burn test.

19. The thermal insulation and fire protection felt product of claim 18, wherein
the scrim comprises filament fibers woven with a third plurality of melted PPS fibers.

20. The thermal insulation and fire protection felt product of claim 18, wherein
the first or the second plurality of mechanically entangled PAN fibers comprise a maximum of 40% by weight of a plurality of inorganic fibers and a remaining plurality of organic fibers.
